(19) United States
(12) Patent Application Publication
(10) Pub. No.: US 2007/0035132 A1
(43) Pub. Date: Feb. 15, 2007

(54) Expandable tubular connection

(75) Inventor: Scott A. Benzie, Houston, TX (US)

Correspondence Address: STREETS & STEELE, 13831 NORTHWEST FREEWAY, SUITE 355, HOUSTON, TX, 77040, US

(73) Assignee: Grinaldi LTD

(21) Appl. No.: 11/201,500

(22) Filed: Aug. 11, 2005

(51) Int. Cl. F16L 25/00

(52) U.S. Cl. 285/334

(57) ABSTRACT

A radially-expandable tubular connection comprises a radially-expandable pin member and a radially-expandable box member. The pin member has an external thread, and a non-threaded external seal surface. The box member has an internal thread for threadably engaging the external thread, and a non-threaded internal seal surface carried by an elongated box nose for engaging the external seal surface. The external and internal threads may be one of square threads, tapered threads, dovetail-shaped threads, and a combination thereof. The elongated box nose has a length, Lₙ, defined according to the equation

$${L}_{n} \leq \frac{1}{2} \sqrt{{OD}_{b} \cdot {T}_{n}} ,$$

where OD_{b}= outside diameter of the box member, and Tₙ= nominal thickness of the box nose. Accordingly, radial expansion of the tubular connection when the external thread of the pin member is threadably engaged within the internal thread of the box member produces deformation of the elongated box nose that urges at least a portion of the internal seal surface into contact with the external seal surface.

### BACKGROUND OF THE INVENTION

1. Field of the Invention

The present invention relates to threaded tubular connections for use in the drilling of wellbores (also known as boreholes) and production of hydrocarbons therefrom. More particularly, the invention relates to threaded connections for downhole tubulars that are designed to be plastically, radially expanded in a wellbore.

2. Background of the Related Art

In the construction, drilling, and/or repair of wellbores, it may be advantageous to use radially-expandable tubulars (also referred to herein as tubular members). The in-situ radial expansion of such tubulars allows for the minimization of conventional reductions (with depth) in wellbore diameter, as well as the isolation of low or high pressure areas in the wellbore, among other things.

Casing joints, liners and other oilfield tubulars are usually connected in an end-to-end manner by threaded connections. The connections may be designed to provide mechanical integrity between the joints and a seal between the interior and exterior of the tubular connection. The seal may be a metal-to-metal seal, an elastomeric seal, a thread seal (e.g., a thread compound seal), or a combination of seals.

When a threaded tubular connection is plastically radially expanded, the male (pin) and the female (box) portions or members of the connection typically undergo different degrees of plastic deformation, both in longitudinal and radial directions. This difference can cause different degrees of radial displacements after expansion and the creation of gaps between the pin and box members of the connection. As a result, the seal surfaces in contact before radial expansion can become separated after expansion.

Problems also arise when the connection is expanded in different well conditions, e.g., under different boundary conditions, or by different methods or modes. As shown in FIGS. 1A, 1B, and 1C, there are three major modes of expansion: tension, compression, and the so-called fix-fix mode.

FIG. 1A is a schematic representation of tubular expansion in the tension or tensile mode. In this case, an expansion force F applied to an expansion mandrel 10 generates tensile longitudinal stresses in a fixed, expanded portion 12 of a tubular 13, while an unfixed, unexpanded portion 14 of the tubular 13 is stress free. This mode is realized, e.g., when expansion is generated by pressure in the expanded portion 12 of the tubular 13 or when the expanded portion 12 of the tubular 13 is anchored and the expansion is produced by pulling a drill pipe (not shown) attached to the expansion mandrel 10.

FIG. 1B is a schematic representation of tubular expansion in a compression mode. In this case, an expansion force F generates compressive longitudinal stress in a fixed, unexpanded portion 14 of the tubular 13 while an unfixed, expanded portion 12 of the tubular 13 is stress free. The compression mode is realized, e.g., when an expansion force is generated by some thrusting (i.e., pulling) device anchored in (or relative to) the unexpanded portion 14 of the tubular 13.

FIG. 1C is a schematic representation of the tubular expansion in a so called “fix-fix” mode. In this case, the tubular 13 is constrained or fixed on both sides of the expansion mandrel 10. This mode prevents longitudinal shrinkage of the tubular 13 during radial expansion which results in high longitudinal stresses in both the expanded portion 12 and the unexpanded portion 14 of the tubular. The fix-fix mode of expansion is realized when the tubular 13 is differentially stuck or packed within a wellbore on both sides of the expansion mandrel 10.

Frequently, the expansion mode can be a combination of the three base modes described above. For example, in the case of expanding a vertically-oriented tubular in a bottom-up direction, the initial expansion mode can be compression, e.g., due to the significant weight of a string containing the tubular above an expansion mandrel, but can become tension mode at the top of the tubular, due to the insignificant weight of the unexpanded portion of the tubular. Additionally, the expansion mode might be a mixed mode in between.

The longitudinal stresses in a threaded tubular connection are transferred through the threads thereof. This creates opposite bending moments in the box member and the pin member adjacent the respective threads thereof that result in different degrees of radial displacement of the pin and box members. As discussed above, in different modes of expansion the longitudinal stresses in the connection during its radial expansion can be substantially different. Therefore, expandable connections (also known in the art as connectors), which might provide an internal seal (i.e., at or near the nose of a pin member) or an external seal (i.e., at or near the nose of a box member) while expanded in one mode of expansion, may lose the seal if expanded in a different mode of expansion. It has therefore been difficult to provide such seals after expansion in different modes using expandable connections known in the art. Therefore, a need exists for a reliable, radially-expandable threaded connection that is capable of providing/maintaining one or more seals after expansion in different well conditions and by different methods.

### DEFINITIONS

Certain terms are defined throughout this description as they are first used, while certain other terms used in this description are defined below:

“Box member” refers to an end portion of a tubular member employing a female threadform. The threadable engagement of a pin member within a box member is commonly called a threaded tubular connection, or simply a threaded connection or a tubular connection.

“Pin member” refers to an end portion of a tubular member employing a male threadform.

“Thread” means a ridge of generally uniform section in the form of a helix on the internal or external surface of a tubular member such as a pipe.

“Threadform” means the profile of a thread in an axial (longitudinal) section or plane for a length of one pitch.

“Tubular member” comprises a joint of pipe (e.g., a casing joint) or a coupling.

### SUMMARY OF THE INVENTION

The above-described needs, problems, and deficiencies in the art, as well as others, are addressed by the present invention in its various aspects and embodiments. For example, in different modes of expansion, the longitudinal stresses experienced by a threaded tubular connection during its plastic radial expansion can be significantly different; varying from compressive to high tensile such as in the case of fix-fix mode of expansion. The longitudinal stresses in the connection are transferred through the pin and box threads and can cause high bending moments in the areas adjacent the respective threads. The high bending moments can significantly influence the degree of radial plastic deformation of the pin and the box members of the connection up to a certain distance from the threads. These bending moments can cause both positive and negative effects on sealability of the connection. One aspect of the present invention relates to the discovery that the geometry of the connection may be manipulated to advantage.

Accordingly, the present invention provides a radially-expandable tubular connection, comprising a radially-expandable pin member and a radially-expandable box member. The pin member has an external thread, and a non-threaded external seal surface. The box member has an internal thread for threadably engaging the external thread, and a non-threaded internal seal surface carried by an elongated box nose for engaging the external seal surface. The external and internal threads may be one of square threads, tapered threads, dovetail-shaped threads, and a combination thereof. The elongated box nose has a length, Lₙ, defined according to the equation

$${L}_{n} \geq \frac{1}{2} \sqrt{{OD}_{b} \cdot {T}_{n}} ,$$

where OD_{b}= outside diameter of the box member, and Tₙ= nominal thickness of the box nose. Accordingly, radial expansion of the tubular connection when the external thread of the pin member is threadably engaged within the internal thread of the box member produces deformation of the elongated box nose that urges at least a portion of the internal seal surface into contact with the external seal surface. The portion of the internal seal surface that is urged into contact with the external seal surface upon radial expansion of the tubular connection may be carried at or near an open end of the elongated box nose.

In particular embodiments, the non-threaded external seal surface is carried by the pin member between the external thread and a shoulder of the pin member that opposes an open end of the elongated box nose when the external thread of the pin member is threadably engaged within the internal thread of the box member. Accordingly, the non-threaded internal seal surface may be carried by the elongated box nose between an open end thereof and the internal thread.

In another aspect, the present invention provides a radially-expandable box member for use with a complementing radially-expandable pin member in forming a radially-expandable tubular connection. The box member comprises an internal thread for threadably engaging an external thread of a complementing radially-expandable pin member, and a non-threaded internal seal surface carried by an elongated box nose for engaging an external seal surface of the complementing pin member. The elongated box nose has a length, Lₙ, defined according to the equation

$${L}_{n} \geq \frac{1}{2} \sqrt{{OD}_{b} \cdot {T}_{n}} ,$$

where OD_{b}= outside diameter of the box member, and Tₙ= nominal thickness of the box nose. Accordingly, radial expansion of a tubular connection employing the box member and the complementing pin member produces deformation of the elongated box nose that urges at least a portion of the internal seal surface into contact with an external seal surface of the complementing pin member.

In a further aspect, the present invention provides a method for making a radially-expandable tubular connection, comprising the steps of making a radially-expandable box member, and making a radially expandable pin member. The radially-expandable box member is made by forming a thread in an internal surface of a box member. The internal thread begins at the base of an elongated box nose having a length, Lₙ, measured from an open end of the box member. Lₙ, is defined according to the equation

$${L}_{n} \geq \frac{1}{2} \sqrt{{OD}_{b} \cdot {T}_{n}} ,$$

where OD_{b}= outside diameter of the box member, and Tₙ= nominal thickness of the box nose. A non-threaded internal seal surface is formed along an inner surface of the elongated box nose. The radially-expandable pin member is made by forming a thread in an external surface of a pin member adjacent an open end thereof that complements the internal thread of the box member, and forming a non-threaded external seal surface adjacent the external thread that complements the non-threaded internal seal surface of the box member.

In particular embodiments, the inventive method further comprises the steps of threadably engaging the external thread of the pin member within the internal thread of the box member to form an expandable tubular connection, and radially expanding the expandable tubular connection to produce deformation of the elongated box nose that urges at least a portion of the internal seal surface into contact with the external seal surface. The portion of the internal seal surface that is urged into contact with the external seal surface upon radial expansion of the tubular connection may be carried at or near an open end of the elongated box nose.

### BRIEF DESCRIPTION OF THE DRAWINGS

A more particular description of the invention, briefly summarized above, is provided by reference to embodiments thereof that are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a schematic representation of tubular expansion in a tension mode.

FIG. 1B is a schematic representation of tubular expansion in a compression mode.

FIG. 1C is a schematic representation of tubular expansion in a “fix-fix” mode.

FIG. 2A shows a fragmentary sectional view of a prior art radially-expandable, threaded tubular connection, prior to radial expansion.

FIG. 2B shows a fragmentary sectional view of the threaded tubular connection of FIG. 2A, after radial expansion in the fix-fix mode.

FIG. 2C shows a fragmentary sectional view of a radially-expandable, threaded tubular connection employing an elongated box nose in accordance with the present invention.

FIG. 2D shows a fragmentary sectional view of the radially-expandable, threaded tubular connection of FIG. 2C, after radial expansion in the fix-fix mode.

### DETAILED DESCRIPTION OF THE INVENTION

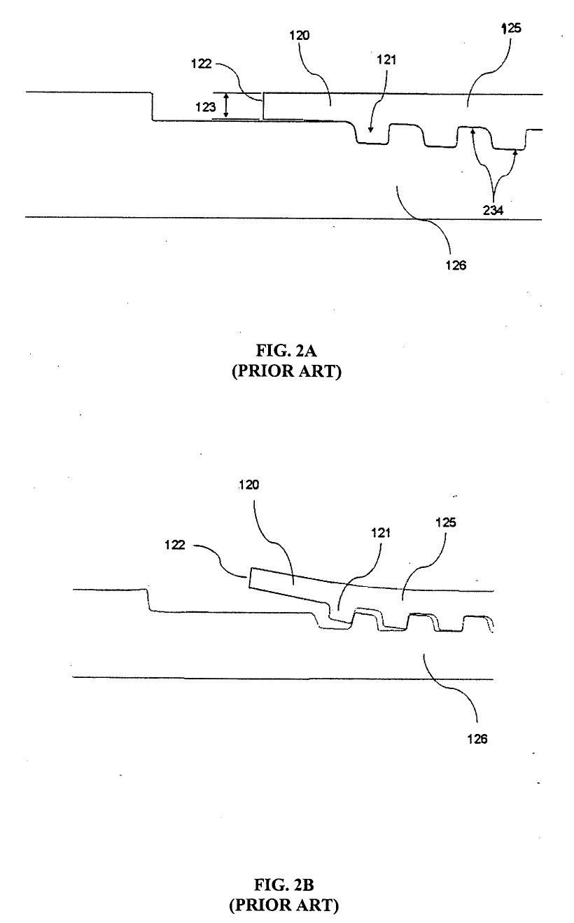

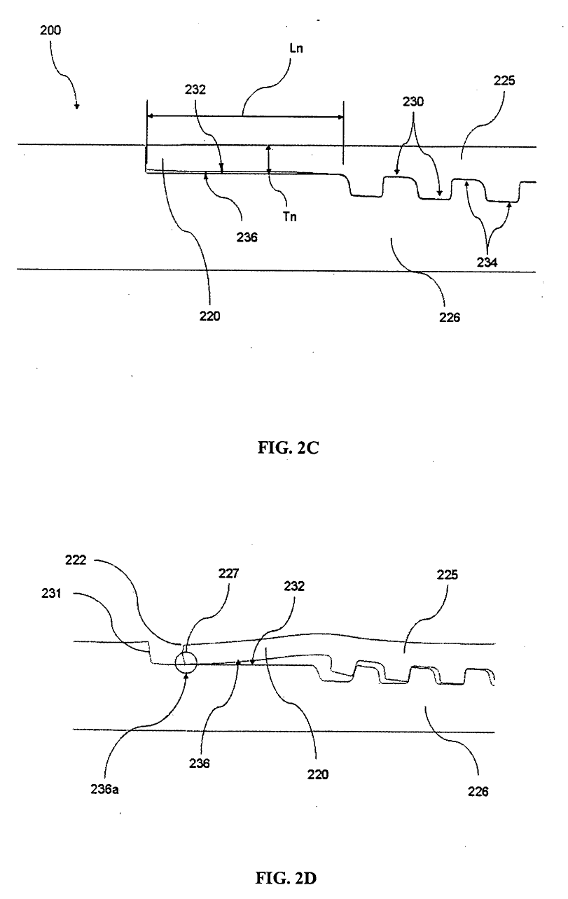

FIG. 2A shows a fragmentary sectional view of a prior art radially-expandable, threaded tubular connection, prior to radial expansion. The connection employs a box member 125 that is threadably engaged within a pin member 126. The box member 125 comprises a box nose 120, defined as a non-threaded portion of the box member between the last thread 121 and the end 122 of the box member. The box nose 120 employs a substantially homogeneous thickness 123 in the radial direction.

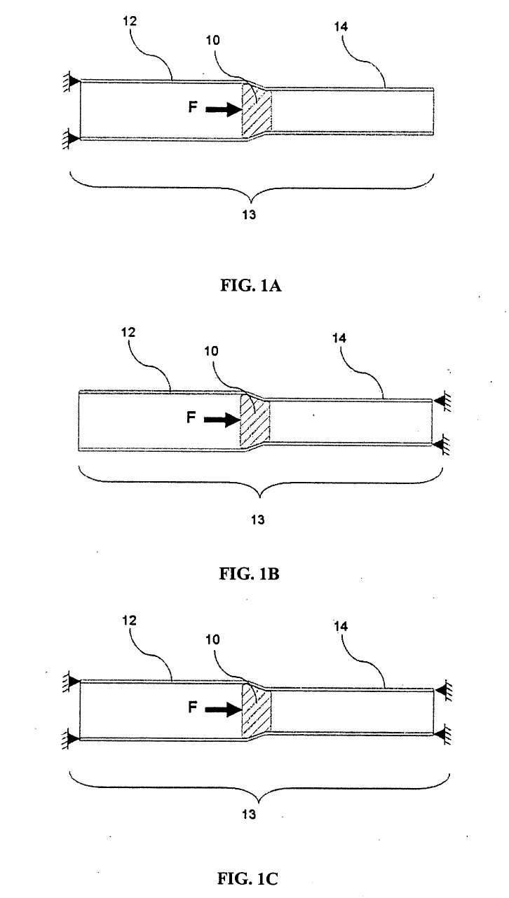

FIG. 2B shows a fragmentary sectional view of the threaded tubular connection of FIG. 2A, after plastic radial expansion in the so-called fix-fix mode (refer to FIG. 1C and related discussion above). In this case, the box nose 120 is plastically deformed away from the pin member 126, and does not develop an interference pressure on the pin member 126 as is desirable for an external sealing engagement.

FIG. 2C shows a fragmentary sectional view of a radially-expandable, threaded tubular connection 200 according to the present invention. The tubular connection 200 comprises a radially-expandable pin member 226 and a radially-expandable box member 225. The pin member 226 has an external thread 230, and a non-threaded external seal surface 232. The external seal surface 232 is carried by the pin member 226 between the external thread 230 and a shoulder 231 (see FIG. 2D) of the pin member that opposes an open end 222 of an elongated box nose 220 (described below).

The box member 225 has an internal thread 234 for threadably engaging the external thread 230 of the pin member, and a non-threaded internal seal surface 236 carried by an elongated box nose 220 for engaging the external seal surface 232 of the pin member 226. The internal seal surface 236 is carried by the elongated box nose 220 between the open end 222 (see FIG. 2D) thereof and the internal thread 234.

The elongated box nose 220 has a length, Lₙ, defined according to the equation

$${L}_{n} \geq \frac{1}{2} \sqrt{{OD}_{b} \cdot {T}_{n}} ,$$

where OD_{b}= outside diameter of the box member 225, and Tₙ= nominal thickness of the elongated box nose 220 (the nose may employ a taper). Accordingly, as illustrated in FIG. 2D, radial expansion of the tubular connection 200 in the so-called fix-fix mode (e.g., when a tubular string is “stuck” within a wellbore section; see FIG. IC and related description above)—when the external thread 230 of the pin member 226 is threadably engaged within the internal thread 234 of the box member 225—produces plastic deformation of the elongated box nose 220 that urges at least a portion 236 a of the internal seal surface 236 of the box member into interfering contact with the external seal surface 232 of the pin member.

As shown in FIG. 2D, the portion 236a of the internal seal surface 236 of the box member that is urged into contact with the external seal surface 232 of the pin member may be carried at or near an open end 222 (see circled region 227) of the elongated box nose 220. The plastic deformation of the elongated box nose 220 is sufficient to achieve a desirable contact pressure at the seal surface portion 236 a to form a reliable external seal between the box and pin members. It will be appreciated by those having ordinary skill in the art that the elongated box nose geometry may be employed to advantage in any of the three major modes of expansion discussed above with reference to FIGS. 1A-1C.

The radially-expandable box member 225 is made by forming the continuous internal thread 234 therein according to the geometry of the elongated box nose 220. Accordingly, the internal thread 234 begins at the “base” of the elongated box nose 220 as defined by the box nose length, Lₙ, measured from the open end 222 of the box member 225. As mentioned above, the length Lₙ is defined according to the equation

$${L}_{n} \geq \frac{1}{2} \sqrt{{OD}_{b} \cdot {T}_{n}} ,$$

where OD_{b}= outside diameter of the box member 225, and Tₙ= nominal thickness of the elongated box nose 220. The non-threaded internal seal surface 236 is formed along an inner surface of the elongated box nose 220. The diameter of the internal seal surface 236 is preferably defined by the roots (i.e., largest diameter portions) of the external thread 234.

The radially-expandable pin member 226 is made by forming a continuous outer thread 230 in an external surface thereof adjacent an open end (not shown) thereof that complements the internal thread 234 of the box member 225. A non-threaded external seal surface 232 is formed in the pin member adjacent the external thread that complements the non-threaded internal seal surface of the box member. The diameter of the external seal surface 232 is preferably defined by the crests (i.e., largest diameter portions) of the external thread 230.

It will be further appreciated by those skilled in the art that the pin and box members described herein may employ any conventional coatings such as, but not limited to, zinc phosphate, manganese phosphate, copper, or any other conventional surface treatments, such as grid blasting, to prevent galling and/or to improve corrosion resistance. Additionally, the threaded tubular connections described herein may comprise known frictional or pressure seal compounds such as, but not limited to, an anaerobic set compounds.

It will be understood from the foregoing description that various modifications and changes may be made in the preferred and alternative embodiments of the present invention without departing from its true spirit. For example, the external and internal threads 234, 230 may be square threads, dovetail-shaped threads or tapered (e.g., Acme-type) threads, as well as combinations or variations thereof in accordance with the known teachings in the art.

This description is intended for purposes of illustration only and should not be construed in a limiting sense. The scope of this invention should be determined only by the language of the claims that follow. The term “comprising” within the claims is intended to mean “including at least” such that the recited listing of elements in a claim are an open set or group. Similarly, the terms “containing,” “having,” and “including” are all intended to mean an open set or group of elements. “A,” “an” and other singular terms are intended to include the plural forms thereof unless specifically excluded. It is the express intention of the applicant not to invoke 35 U.S.C. § 112, paragraph 6 for any limitations of any of the claims herein, except for those in which the claim expressly uses the words “means for” together with an associated function.

What is claimed is:

1. A radially-expandable tubular connection, comprising:
a radially-expandable pin member having
an external thread, and
a non-threaded external seal surface; and
a radially-expandable box member having
an internal thread for threadably engaging the external thread, and
a non-threaded internal seal surface carried by an elongated box nose for engaging the external seal surface,
the elongated box nose having a length, Lₙ, defined according to the equation
$${L}_{n} \geq \frac{1}{2} \sqrt{{OD}_{b} \cdot {T}_{n}} ,$$
where OD_{b}= outside diameter of the box member, and
Tₙ= nominal thickness of the box nose;
whereby radial expansion of the tubular connection when the external thread is threadably engaged within the internal thread produces deformation of the elongated box nose that urges at least a portion of the internal seal surface into contact with the external seal surface.

2. The tubular connection of claim 1, wherein the external and internal threads are one of square threads, tapered threads, dovetail-shaped threads, and a combination thereof.

3. The tubular connection of claim 1, wherein the non-threaded external seal surface is carried by the pin member between the external thread and a shoulder of the pin member that opposes an open end of the elongated box nose when the external thread is threadably engaged within the internal thread.

4. The tubular connection of claim 1, wherein the non-threaded internal seal surface is carried by the elongated box nose between an open end thereof and the internal thread.

5. The tubular connection of claim 1, wherein the portion of the internal seal surface that is urged into contact with the external seal surface upon radial expansion of the tubular connection is carried at or near an open end of the elongated box nose.

6. A radially-expandable box member for use with a complementing radially-expandable pin member in forming a radially-expandable tubular connection, comprising:
an internal thread for threadably engaging an external thread of a complementing radially-expandable pin member; and
a non-threaded internal seal surface carried by an elongated box nose for engaging an external seal surface of the complementing pin member;
the elongated box nose having a length, Lₙ, defined according to the equation
$${L}_{n} \geq \frac{1}{2} \sqrt{{OD}_{b} \cdot {T}_{n}} ,$$
where OD_{b}= outside diameter of the box member, and
Tₙ= nominal thickness of the box nose;
whereby radial expansion of a tubular connection employing the box member and the complementing pin member produces deformation of the elongated box nose that urges at least a portion of the internal seal surface into contact with an external seal surface of the complementing pin member.

7. The box member of claim 6, wherein the internal threads are one of square threads, tapered threads, dovetail-shaped threads, and a combination thereof.

8. The box member of claim 6, wherein the non-threaded internal seal surface is carried by the elongated box nose between an end thereof and the internal thread.

9. The box member of claim 6, wherein the portion of the internal seal surface that is urged into contact with an external seal surface of a pin member upon radial expansion of the tubular connection is carried at or near an open end of the elongated box nose.

10. A method for making a radially-expandable tubular connection, comprising the steps of:
making a radially-expandable box member by
forming a thread in an internal surface of a box member, the internal thread beginning at the base of an elongated box nose having a length, Lₙ, measured from an open end of the box member, Lₙ being defined according to the equation
$${L}_{n} \geq \frac{1}{2} \sqrt{{OD}_{b} \cdot {T}_{n}} ,$$
where OD_{b}= outside diameter of the box member, and
Tₙ= nominal thickness of the box nose, and
forming a non-threaded internal seal surface along the elongated box nose; and
making a radially-expandable pin member by
forming a thread in an external surface of a pin member adjacent an open end thereof that complements the internal thread of the box member, and
forming a non-threaded external seal surface adjacent the external thread that complements the non-threaded internal seal surface of the box member.

11. The method of claim 10, further comprising the steps of:
threadably engaging the external thread of the pin member within the internal thread of the box member to form an expandable tubular connection; and
radially expanding the expandable tubular connection to produce deformation of the elongated box nose that urges at least a portion of the internal seal surface into contact with the external seal surface.

12. The method of claim 11, wherein the portion of the internal seal surface that is urged into contact with the external seal surface upon radial expansion of the tubular connection is carried at or near an open end of the elongated box nose.
